(19) United States
(12) Patent Application Publication
(10) Pub. No.: US 2014/0121998 A1
(43) Pub. Date: May 1, 2014

(54) Systems and Methods for Adverse Combustion Avoidance and Correction

(71) Applicant: GENERAL ELECTRIC COMPANY, Schenectady, NY (US)

(72) Inventors: Anthony Wayne Krull, Greenville, SC (US); Timothy Andrew Healy, Greenville, SC (US); Garth Curtis Frederick, Greenville, SC (US)

(73) Assignee: General Electric Company, Schenectady, NY (US)

(21) Appl. No.: 13/661,716

(22) Filed: Oct. 26, 2012

(51) Int. Cl. G01L 7/00; G06F 19/00

(52) U.S. Cl. 702/50

(57) ABSTRACT

Systems and methods for avoidance and correction of potentially adverse combustion states such as flame holding and flashback are disclosed. According to one embodiment of the disclosure, one or more sensors acquire sensor data from one or more sensors associated with combustion. An operational limit margin (OLM) is calculated using an OLM model and based at least in part on the sensor data. A determination is made as to the presence of a potentially adverse combustion state based at least in part on the OLM and the model. Once determined, corrective action may be taken to avoid an adverse combustion event prior to occurrence of the event.

### TECHNICAL FIELD

Embodiments of the disclosure relate generally to combustion systems, and more particularly, to systems and methods for mitigating adverse combustion events.

### BACKGROUND

Combustion systems initiate and maintain combustion of a fuel. Combustion of the fuel at times or locations which are unintended may result in undesirable wear on equipment. This wear may result in failure and subsequent damage.

### BRIEF DESCRIPTION OF THE DISCLOSURE

Some or all of the above needs and/or problems may be addressed by certain embodiments of the disclosure. Certain embodiments may include systems and methods for mitigating or preventing adverse combustion events. According to one embodiment of the disclosure, there is disclosed a system. The system can include a data acquisition module configured to acquire sensor data from one or more sensors associated with one or more power generation components. The system includes an operational limit margin (OLM) model module configured to compare at least a portion of the sensor data with a OLM model to determine presence of a combustion state in the one or more power generation components. An output module may be configured to generate an output based at least in part on the determined presence of a combustion state.

Also disclosed herein is a method for mitigating or preventing adverse combustion events. In one implementation, sensor data is acquired from one or more sensors associated with combustion. The operational limit margin (OLM) is calculated using an operational limit margin model and based at least in part on the sensor data. Presence of a potentially adverse combustion state is determined, based at least in part on the OLM model.

Other embodiments, systems, methods, apparatus, aspects, and features of the disclosure will become apparent to those skilled in the art from the following detailed description, the accompanying drawings, and the appended claims.

### BRIEF DESCRIPTION OF THE DRAWINGS

The detailed description is set forth with reference to the accompanying drawings, which are not necessarily drawn to scale. The use of the same reference numbers in different figures indicates similar or identical items.

FIG. 1 is a diagram of an architecture comprising a turbine unit with a flame holding margin model module according to an embodiment of the disclosure.

FIG. 2 is a flow diagram of a process of initiating corrective action to prevent an adverse combustion event according to an embodiment of the disclosure.

FIG. 3 illustrates a timeline of determination and correction of a potentially adverse combustion state to prevent an adverse combustion event according to an embodiment of the disclosure.

FIG. 4 is a flow diagram of a process of modifying an operational limit margin model according to an embodiment of the disclosure.

FIG. 5 illustrates a timeline of determination and correction of an adverse combustion state according to an embodiment of the disclosure.

### DETAILED DESCRIPTION OF EMBODIMENTS OF THE DISCLOSURE

Illustrative embodiments of the disclosure will now be described more fully hereinafter with reference to the accompanying drawings, in which some, but not all embodiments of the disclosure are shown. The disclosure may be embodied in many different forms and should not be construed as limited to the embodiments set forth herein; rather, these embodiments are provided so that this disclosure will satisfy applicable legal requirements. As noted above, like numbers refer to like elements throughout.

Illustrative embodiments of the disclosure are directed to, among other things, an operational limit margin (OLM) model to determine conditions which may result in an adverse combustion event and which may be modified to include data associated with actual adverse events. As an overview, combustion is an exothermic chemical reaction in which energy is released. Combustion may take place in boilers, turbines, furnaces, engines, and so forth. Combustion systems may dispense fuel, an oxidizer, and other reactants using nozzles or injectors. During normal operation of the nozzle, combustion proceeds external to a nozzle body or at a controlled point on the nozzle body. However, in some circumstances, an adverse combustion event may result in a transient condition in which combustion occurs at least partially within the nozzle, which may be termed “flashback.” When the combustion at least partially within the nozzle continues for more than a pre-determined period of time, the adverse combustion event may be termed “flame holding.” In some instances, combustion may occur at very lean F/A (fuel/air) ration closer to a lean blowout (LBO) boundary in order to maintain relatively low NOx emissions. F/A ratio leaner than the LBO boundary value can result in partial or complete blowout of the flame, wherein the adverse combustion event may be termed “lean blowout.” A potentially adverse combustion state may be deemed based on one or more conditions which, when continued for a pre-determined time interval, have a probability above a pre-determined threshold of resulting in an adverse combustion event within the one or more combustors.

Flashback, flame holding, and lean blowout events can result in undesired operation of the combustion system. Due to the presence of combustion in undesired locations, the combustion system may experience undesired wear or failure. Such failure may result in damage to other components in the system. Thus, at least one technical effect or solution of certain embodiments of the disclosure can mitigate adverse combustion events, and improve operation of the combustion system. In certain instances, at least one technical effect or solution of certain embodiments of the disclosure can minimize or prevent undesired wear or failure of the combustion system.

Turbines and other combustion devices are being adapted to use wider varieties of fuels, or mixes of various fuels. Furthermore, the fuel or fuel mix may be changed during operation of the combustion device. For example, to account for changes in availability, price, and so forth, a fixed turbine used in power generation may be transitioned from kerosene to natural gas to shale gas while operating. These different fuels may result in undesired operation, including adverse combustion events and operation in an adverse combustion state. Continuing the example, shale gas may contain concentration of ethane which may increase the likelihood of flame holding.

The system and methods described herein allow for the use of an operational limit margin (“OLM”) model, which is used to detect potentially adverse combustion conditions and avoid adverse combustion events. These potentially adverse combustion conditions may, but need not always, result in an adverse combustion event. These adverse combustion events include, but are not limited to, flashback, flame holding, and lean blowout. When an adverse combustion event does occur, the system is configured to modify the OLM to prevent re-occurrence should the same or similar conditions occur. Among other advantages, the OLM model allows for easier and safer operation with fuels of varying characteristics.

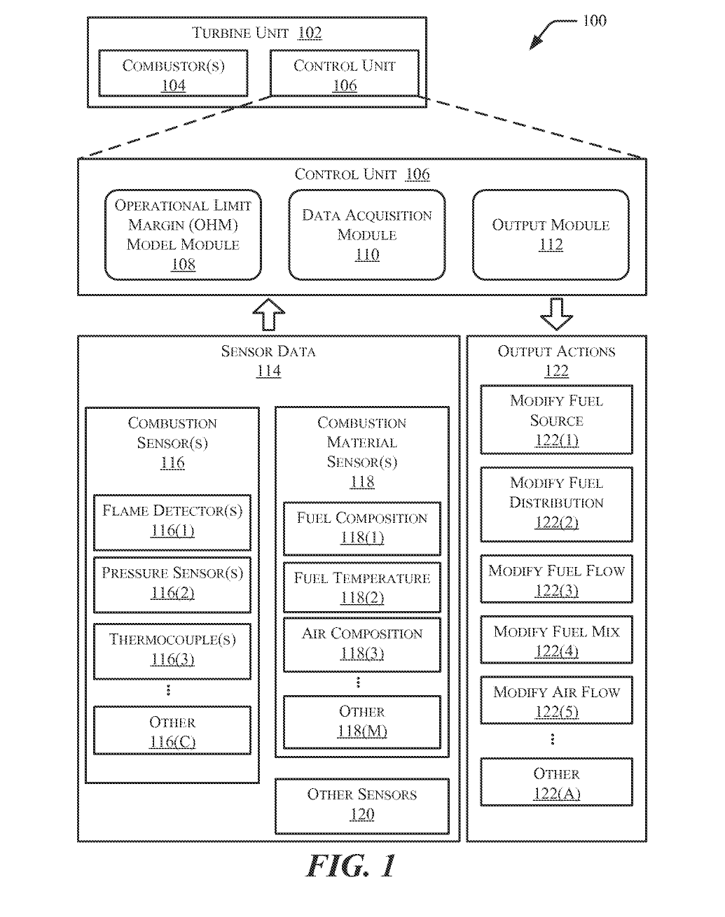

FIG. 1 is a diagram of an architecture 100 which may utilize a flame holding margin model module. A turbine unit 102 is shown. This turbine unit 102 may be fixed or mobile. Output of the turbine may be rotational energy in the form of a spinning shaft, thrust from exhaust of materials, or a combination thereof.

The turbine unit 102 may comprise one or more power generation components, such as combustors 104, and a control unit 106. The one or more combustors 104 are configured to dispense and combust at least a portion of the reactants associated with a combustion reaction. For example, the combustors 104 may comprise one or more nozzles configured to dispense a liquid fuel. The one or more combustors 104 include, but are not limited to, can, annular, cannular, and so forth. Each combustor 104 may comprise a plurality of nozzles or injectors. The combustor 104 or components therein may be individually controllable. For example, where the combustor 104 comprises five nozzles, in some implementations, each nozzle or a group of nozzles may be controlled independently of one another.

The turbine unit 102 comprises a control unit 106. The control unit 106 is configured to respond to inputs associated with the turbine unit 102 and provide one or more output actions at least partly in response. The control unit 106 may comprise an operational limit margin (OLM) model module 108. The OLM model module 108 is configured to determine a potentially adverse combustion state based on inputs and to generate outputs suitable for avoiding the potentially adverse combustion state. In one implementation, the OLM model module 108 may be configured to compare at least a portion of the sensor data with an OLM model to determine presence of a potentially adverse combustion state in the one or more combustors 104. In another implementation, the OLM model module 108 may be configured to compare at least a portion of the sensor data with the OLM model to determine a state of the combustion. For example, the OLM model module 108 may determine whether the turbine is operating in an acceptable combustion state, in a potentially adverse combustion state, or in an adverse combustion state. The OLM model module 108 may then be configured to generate one or more outputs based at least in part on the determined combustion state.

The OLM model module 108 is also configured to receive data associated with an actual adverse combustion state or event and modify the model based on at least a part of this data. In this way, the OLM model module 108 adapts to the particular operational conditions associated with that particular turbine unit 102. Operation of the turbine unit 102 may change over time as fuels change, parts wear, equipment is modified, and so forth. By providing the OLM model module 108 with the capacity to adapt, the OLM model therein may also adapt. In some implementations, the OLM model may be configured to discard or “forget” certain events.

The control unit 106 includes a data acquisition module 110 and an output module 112. The data acquisition module 110 is configured to acquire data associated with the one or more combustors 104, or other data associated with operation of the turbine unit 102. The data acquisition module 110 acquires sensor data 114 from one or more sensors and provides at least a portion of this sensor data 114 to the OLM model module 108.

The sensor data 114 includes data from one or more combustion sensors 116, combustion material sensors 118, and other sensors 120. The combustion sensors 116 are configured to provide data associated with the combustion process, such as within or associated with the one or more combustors 104. The combustion sensors 116 may include one or more flame detectors 116(1), pressure sensors 116(2), thermocouples 116(3), and other combustion sensors 116(C). The flame detectors 116(1) may comprise one or more optical, ionization, or other devices configured to generate data indicative of a presence or absence of a combustion reaction. The pressure sensors 116(2) may comprise one or more piezoelectric, capacitive, optical, potentiometric, resonant, or other devices configured to generate data indicative of pressure. The thermocouples 116(3) may comprise one or more solid state devices configured to generate data indicative of temperature. The other combustion sensors 116(C) may include devices to determine chemical composition, burner tube velocity, fluid velocity, and so forth.

The combustion material sensors 118 provide information about the inputs to the combustion reaction, such as fuel and oxidizer. This may include sensors for measuring fuel composition 118(1), fuel temperature 118(2), air composition 118(3), and other 118(M) factors. The fuel composition sensor 118(1) may be configured to use optical, electrical, chemical, or other effects to determine at least a portion of the constituents within fuel consumed by the one or more combustors 104. For example, the fuel composition sensor 118(1) may determine the concentration of sulfur, hydrogen, water, and so forth. The fuel temperature sensors 118(2) may provide data about the temperature of the fuel. The fuel temperature sensors 118(2) may comprise one or more optical, solid state, or other sensors configured to provide data indicative of temperature. The air composition sensors 118(3) may be configured to use optical, electrical, chemical, or other effects to determine at least a portion of the constituents in air being used as an oxidizer in the combustion reaction. The air composition sensors 118(3) may be configured to determine ambient humidity, barometric pressure, temperature, and so forth. The other sensors 120 may include inputs from operator controls such as a command to increase or decrease power output of the turbine unit 102, data feeds from utility customers, facility alarms, and so forth.

A data acquisition module 110 is configured to receive or otherwise acquire the sensor data 114. The data acquisition module 110 may include electronic components for polling the sensors, a network interface to receive data from sensors coupled to a network, and so forth. The data acquisition module 110 provides at least a portion of the sensor data 114 to the OLM model module 108.

The control unit 106 includes an output module 112 configured to generate an output based at least in part on the determined presence of a potentially adverse combustion state, actual adverse combustion state, or other control inputs. The output module 112 provides signals which, when actuators or other devices respond thereto, produce output actions 122 which change at least a portion of the combustion parameters affecting the operation of the turbine unit 102. These combustion parameters include, but are not limited to, fuel mix, air flow, fuel composition, or fuel source.

The output actions 122 may alter the combustion parameters by modifying a fuel source 122(1), modifying fuel distribution 122(2), modifying fuel flow 122(3), modifying fuel mix 122(4), modifying air flow 122(5), and other output actions 122(A). Modifying the fuel source 122(1) may comprise changing from one fuel source to another, such as, for example, switching from a primary fuel reservoir to a secondary reservoir. The modification in fuel distribution 122(2) may occur with varying levels of granularity ranging from an individual nozzle in a single combustor 104, to a group of nozzles, a group of combustors, or all combustors 104 in the turbine unit 102. For example, a group or a gang of nozzles may be controlled by one valve, allowing changes in the fuel distribution to that gang. The modification of fuel flow 122(3) may include increasing or decreasing a quantity of fuel fed to the one or more combustors 104. The fuel mix modification 122(4) may involve changing at least some of the composition of the fuel passed to the combustors 104 for combustion. For example, the fuel mix modification 122(4) may use one or more valves to inject hydrogen into the fuel stream. The modification of air flow 122(5) may include changing the volume of air, the velocity of air, the composition of air, the temperature of air, and so forth which are fed to the combustors 104. For example, blowers may be adjusted to provide a selected volume of air into the combustors 104.

While a turbine unit 102 is depicted herein, in other implementations, other devices may utilize the OLM model module 108. For example, boilers, furnaces, and so forth may monitor and control to mitigate adverse combustion events as described herein. Additionally, while the control unit 106 is depicted as a single unit, in some implementations, the control unit 106 and the functions and modules described herein may be distributed across multiple devices.

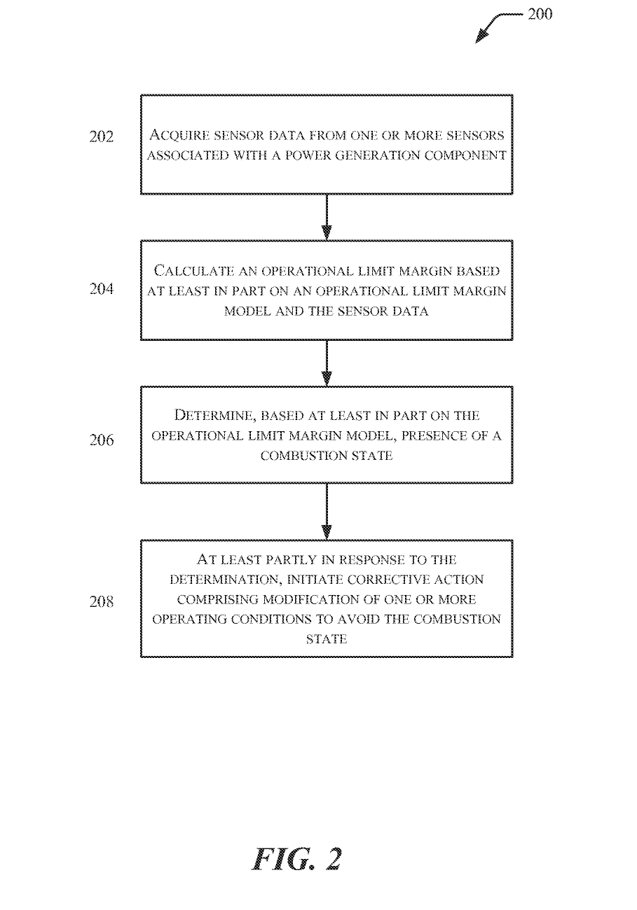

FIG. 2 is a flow diagram 200 of a process of initiating corrective action to prevent an adverse combustion event or state according to an embodiment of the disclosure. This process may be implemented by the OLM (operational limit margin) model module 108.

Block 202 acquires sensor data 114 from one or more sensors associated with combustion. These sensors may be the combustion sensors 116, the combustion material sensors 118, or a combination thereof. For example, the one or more sensors may include a flame detector configured to monitor at least a portion of the combustion.

Block 204 calculates the OLM based at least in part on the sensor data 114. The OLM model is configured with one or more margins within which an acceptable combustion state is expected as well as a potentially adverse combustion state. The OLM model may be pre-loaded or configured, and then modified by operational data such as the sensor data 114 acquired during operation of the device. The OLM model may have one or more thresholds to set or affect the margins. In one implementation, the OLM model may be configured with a particular bias or weighting to apply to input such as the sensor data 114 or in applying the model. For example, the OLM model may be biased in favor of a more conservative model which is more likely to take corrective action.

The OLM model may access and utilize data such as a history of corrective output actions 122. For example, the OLM model may be designed to introduce a delay or wait period between corrective actions, or be configured to take a different set of actions in the event of repeated excursions into potentially or actually adverse combustion states. This delay may be used to minimize oscillation between combustion states, minimize stress on operational components due to state changes, and so forth.

Block 206 determines, based at least in part on the OLM model, the presence of a potentially adverse state of the combustion. For example, the OLM model may indicate that given data from the flame detectors 116(1) and pressure sensors 116(2) the conditions existing in the combustor 104 are prone to flashback. In another example, the OLM model may indicate given data from the flame detectors 116(1) and pressure sensors 116(2) the conditions existing in the combustor are prone to lean blowout. The potentially adverse combustion state may be deemed as one or more conditions which, when continued for a pre-determined time interval, have a probability above a pre-determined threshold of resulting in a flame holding, a flashback, or lean blowout within the one or more combustors 104.

Block 208, at least partly in response to the determination, initiates one or more corrective actions to modify the combustion to effect a transition of the combustion from the potentially adverse combustion state to an acceptable combustion state. For example, output actions 122, such as modifying the fuel mix 122(4) by including a fuel additive, may be initiated. As described above, in one implementation, the combustion may be an exothermic reaction of one or more fuels and one or more oxidizers within the turbine unit 102. The turbine unit 102 may comprise one or more combustors 104.

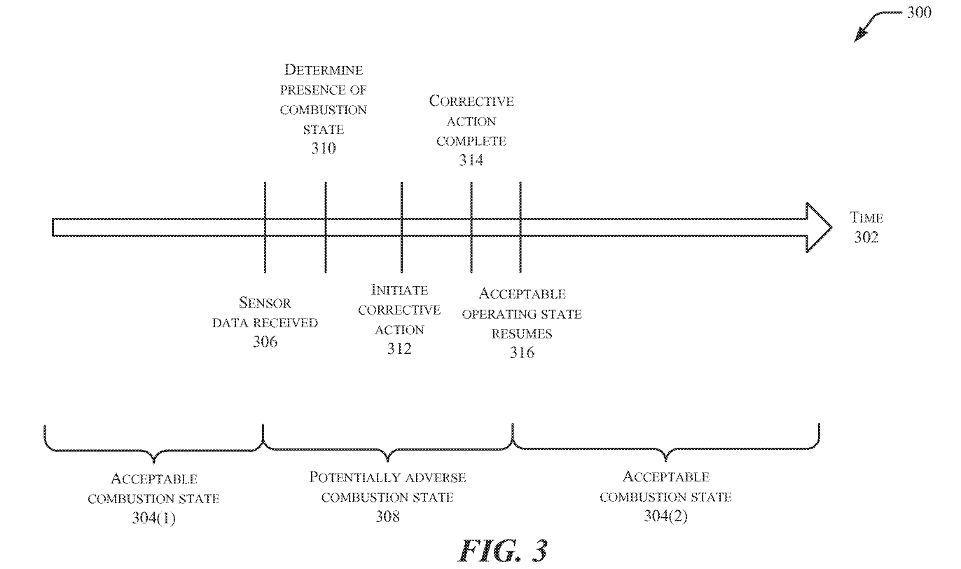

FIG. 3 illustrates a timeline 300 of determination and correction of a potentially adverse combustion state to prevent an adverse combustion event. In this figure, time increases along the line of arrow 302 from left to right as depicted in this figure. During an acceptable combustion state 304(1) interval, the one or more combustors 104 are operating within one or more pre-determined operating boundaries.

At time 306, the sensor data 114 is received at or after onset of a potentially adverse combustion state 308. In some implementations, the sensor data 114 may be provided at regular intervals, or may be provided upon occurrence of a pre-defined condition.

At least a portion of this sensor data 114 is processed by the OLM model module 108 of the control unit 106. As a result of this processing and based at least in part on the sensor data 114, at time 310 presence of a potentially adverse combustion state is determined. For example, the combustion conditions are commensurate with a high likelihood of flashback in one or more nozzles of the combustors 104. At this time, the flashback has not occurred, but the conditions are such that the flashback is likely to occur. In another example, the combustion conditions are commensurate with a high likelihood of lean blowout in one or more of the combustors 104. At this time, the lean blowout has not occurred, but the conditions are such that the lean blowout is likely to occur.

At time 312, corrective action is initiated. For example, the output actions 122 may be used to adjust the operating conditions. At least partly in response to these output actions 122 or when the corrective action is complete at time 314, at time 316, the turbine unit 102 enters an acceptable combustion state 304(2). This acceptable combustion state 304(2) may or may not be optimal. However, the acceptable combustion state is one in which the system operates within established boundaries. For example, modifying the fuel distribution 122(2) may be used to reduce likelihood of a flashback or lean blowout in a particular combustor 104. However, this reduction may result in lower power output of the turbine unit 102. The acceptable combustion state may be defined in some implementations to include this reduced power state, in preference to a complete system failure which may result from the adverse operating event. Thus, in some implementations, the acceptable combustion state 304(1) before corrective action may not be the same or similar to the acceptable combustion state 304(2) after corrective action.

The control unit 106 may be configured to resume a previous set of combustion parameters after a corrective action. For example, after a pre-determined time interval in the acceptable combustion state 304(2), the control unit 106 may initiate output actions 122 to resume the configuration used prior to the potentially adverse combustion state 310, such as occurred during the acceptable combustion state 304(1). For example, the acceptable combustion state 304(1) may be configured to provide optimal power output of the turbine unit 102. The potentially adverse combustion state 310 may have been the result of some transient contamination of the fuel which has since cleared. The corrective action may have resulted in a slight decrease in the turbine power output during the acceptable combustion state 304(2). Thus, the control unit 106 may be configured to transition the turbine unit 102 such that the combustion parameters revert to those present before the potentially adverse combustion state. In this way, the system may avoid becoming fixed into an undesired state.

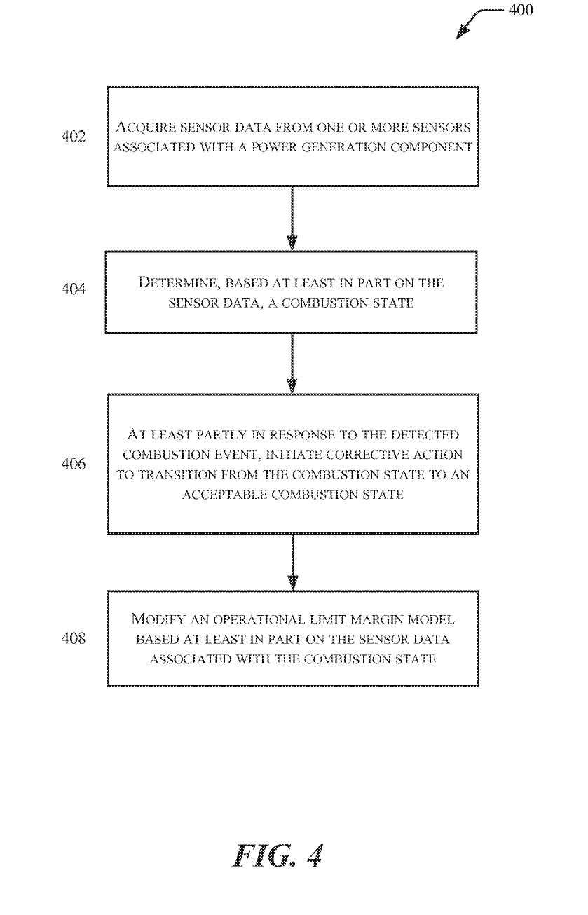

FIG. 4 is a flow diagram 400 of a process of modifying an operational limit margin model according to an embodiment of the disclosure. The OLM model in the OLM model module 108 may be updated based on information associated with actual adverse events. The OLM model module 108 may be modified manually such as by a user, automatically such as by utilizing machine learning techniques, or a combination thereof. These machine learning techniques may include, but are not limited to, neural networks, decision trees, expert systems, reinforcement learning, genetic programming, and so forth.

Such modification allows the OLM model to become more accurate over time with respect to the turbine unit 102. As mentioned above, each turbine unit 102 may differ from others. For example, different sensor options may be installed, operating parameters may vary, fuel composition may change, equipment wears, and so forth. By modifying the OLM model to incorporate actual adverse events, overall operation of the system is improved.

Block 402 acquires sensor data 114 from one or more sensors associated with one or more combustors 104, burners, or combustion devices. For example, a flame detector 116(1) may indicate flame holding in a particular combustor 104 while fuel composition data 118(1) may indicate presence of ethane in the fuel above a pre-determined threshold level. In another example, one or more detectors or sensors may indicate certain fuel/air ratios in any number of particular combustors 104, which may be indicative of a lean blowout in one or more combustors 104.

Block 404 determines, based at least in part on the sensor data, an adverse combustion state. Continuing one of the above examples, the control unit 106 may recognize the flame holding as an adverse event. Continuing another of the above examples, the control unit 106 may recognize the lean blowout as an adverse event.

Block 406, at least partly in response to the detected adverse combustion event, initiates corrective action to transition from the adverse combustion state to an acceptable combustion state. For example, the output actions 122 may be to modify the fuel source 122(1) to a backup reservoir while decreasing air flow 122(5) and modifying fuel distribution 122(2) to the affected combustor 104. For example, the output actions 122 may be to modify the fuel and/or air to the affected combustor 104.

Block 408 modifies the OLM model based at least in part on the sensor data 114 associated with the adverse combustion state. This may include data at the time of the event as well as data for some interval before the event. For example, the data acquisition module 110 may be configured to acquire and store the sensor data 114 for the previous fifteen minutes. This data may be retrieved and correlated with the actual adverse event and associated adverse combustion state. Based at least in part on this data, should the same or similar conditions occur at another point in the future, the OLM model module 108 would be able to recognize the potentially adverse combustion state and initiate corrective action before the adverse combustion event occurs.

In some implementations, the OLM model may be updated after a pre-determined number of adverse events. For example, a single adverse event may not be added to the OLM model, but occurrence of five adverse events within a particular time interval may be. By setting the pre-determined number of adverse events, the OLM model may avoid being populated with data associated with spurious events.

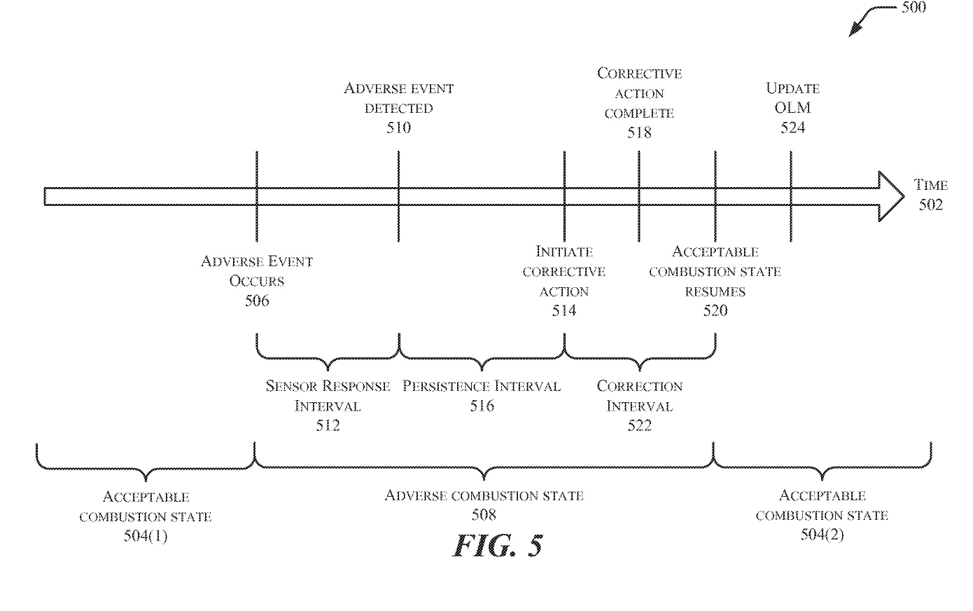

FIG. 5 illustrates a timeline 500 of determination and correction of an adverse combustion state according to an embodiment of the disclosure. Similar to FIG. 3 above, time is indicated by arrow 502 increasing from left to right. Initially, a first acceptable combustion state 504(1) is present in the turbine unit 102. However, at time 506, an adverse event occurs. For example, a nozzle in one of the combustors 104 may experience a flashback and flame holding, or a lean blowout. At time 506, the system is deemed to have entered an adverse combustion state 508. At time 510, the adverse event is detected. For example, the flame detector sensor 116(1) may be polled and may provide data indicative of the flame holding. In another example, a detector or sensor may be polled and may provide data indicative of the lean blowout. The interval from the adverse event occurrence 506 to the adverse event detection 510 may be described as a sensor response interval 512. At time 514, corrective action is initiated, such as described above. For example, the output actions 122 may include modifying fuel distribution 122(2) and/or air distribution 122(5) to the affected nozzle. The interval between the adverse event detection 510 and the initiation of corrective action 514 may be termed a persistence interval 516. At time 518, the corrective action is completed, and at time 520, an acceptable combustion state 504(2) is attained. The time from the initiation of corrective action 514 to the resumption of the acceptable combustion state 520 may be termed a correction interval 522. At time 524, the OLM model in the OLM model module 108 is updated to include the information associated with the adverse event occurrence 506. As described above, the update of the OLM model may occur after a pre-determined number of adverse events have taken place.

As time progresses, as described above with regard to FIG. 3, the system may be transitioned such that the combustion parameters of the acceptable combustion state 504(2) may be adjusted so that the combustion parameters associated with the acceptable combustion state 504(1) are re-attained. This transition from one acceptable combustion state to another may be done gradually or abruptly.

The different intervals may vary according to nature of the adverse event, conditions at the time of the event, corrective actions taken, and so forth. However, the overall duration of the adverse combustion state 508 may be configured such that it is less than the time associated with failure of components within the turbine unit 102. In one implementation, the sensor response interval 512 may be less than about three seconds, while the persistence interval 516 may be less than about three seconds. The correction interval 522 may be less than about one-half of a second. These intervals may be adjusted as desired. For example, the sampling rate of the sensors 116-120 may be increased to reduce the sensor response interval 512. Or additional processing resources within the control unit 106 may be employed to reduce the persistence interval 516.

In some implementations, a delay or wait period may be introduced following initiation of corrective action, such as taking one of the output actions 122 described above. This delay may be introduced to avoid oscillation in combustion states.

Illustrative systems and methods are described above. Some or all of these systems and methods may, but need not, be implemented at least partially by an architecture such as those shown in FIGS. 1-5. It should be understood that certain acts in the methods need not be performed in the order described, may be rearranged or modified, and/or may be omitted entirely, depending on the circumstances. Also, any of the acts described above with respect to any method may be implemented by any number of processors or other computing devices based on instructions stored on one or more computer-readable storage media.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The claimed disclosure is:

1. A system, comprising:
a data acquisition module configured to acquire sensor data from one or more sensors associated with one or more power generation components;
an operational limit margin (OLM) model module configured to compare at least a portion of the sensor data with an OLM model to determine presence of a combustion state in the one or more power generation components; and
an output module configured to generate an output based at least in part on the determined presence of a combustion state.

2. The system of claim 1, the combustion state comprising one or more conditions which, when continued for a pre-determined time interval, have a probability above a pre-determined threshold of resulting in a combustion event within the one or more power generation components.

3. The system of claim 1, the one or more sensors comprising a flame detector, a pressure sensor, or a thermocouple.

4. The system of claim 1, the output comprising modifying one or more combustion parameters of the one or more power generation components.

5. The system of claim 4, the one or more combustion parameters comprising fuel mix, air flow, fuel composition, or fuel source.

6. The system of claim 1, the OLM model module further configured to modify the OLM based at least in part on sensor data associated with a combustion event.

7. The system of claim 6, the adverse combustion state comprising a flame holding event within the one or more power generation components.

8. The system of claim 6, the combustion state comprising a flashback within the one or more power generation components.

9. A system, comprising:
a memory configured to store sensor data from a plurality of sensors associated with combustion;
an operational limit margin (OLM) model module configured to:
access the memory and compare at least a portion of the sensor data with an OLM model to determine a state of the combustion; and
generate one or more outputs based at least in part on the determined combustion state.

10. The system of claim 9, the combustion state comprising an acceptable combustion state or a potentially adverse combustion state.

11. The system of claim 9, the plurality of sensors comprising one or more of a flame detector, a pressure sensor, or a thermocouple.

12. The system of claim 9, the OLM model module further configured to modify the OLM based at least in part on the sensor data.

13. The system of claim 9, the one or more outputs comprising modification of one or more inputs to the combustion.

14. A method, comprising:
acquiring sensor data from one or more sensors associated with combustion;
calculating an operational limit margin (OLM) with an operational limit margin model and based at least in part on the sensor data; and
determining, based at least in part on the OLM, presence of a potentially adverse combustion state.

15. The method of claim 14, the one or more sensors comprising a flame detector configured to monitor at least a portion of the combustion.

16. The method of claim 14, further comprising generating an output based at least in part on the determination of the potentially adverse combustion state.

17. The method of claim 14, the combustion comprising an exothermic reaction of one or more fuels and one or more oxidizers within a turbine comprising one or more combustors.

18. The method of claim 17, the potentially adverse combustion state comprising one or more conditions which, when continued for a pre-determined time interval, have a probability above a pre-determined threshold of resulting in a flame holding or a flashback within the one or more combustors.

19. The method of claim 14, further comprising, at least partly in response to the determination, initiating one or more actions comprising modification of the combustion to effect a transition of the combustion from the potentially adverse combustion state to an acceptable combustion state.

20. The method of claim 14, further comprising modifying the OLM model based at least in part on sensor data associated with an adverse combustion state.
